(19) United States
(12) Patent Application Publication
(10) Pub. No.: US 2006/0280583 A1
(43) Pub. Date: Dec. 14, 2006

(54) Top rack with side load descent mechanism

(76) Inventors: Joseph J. Settelmayer, Fieldbrook, CA (US); Scott R. Allen, Fieldbrook, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/238,076

(22) Filed: Sep. 27, 2005

Related U.S. Application Data
(60) Provisional application No. 60/613,927, filed on Sep. 27, 2004.

(51) Int. Cl. B60P 9/00

(52) U.S. Cl. 414/462

(57) ABSTRACT

Rack systems for carrying cargo on a vehicle roof include mechanisms for delivering cargo to the side of the vehicle. Assist devices may be employed to raise and lower cargo.

### CROSS-REFERENCE TO RELATED APPLICATION

This application claims priority under 35 U.S.C. § 119 to U.S. Provisional Patent Application Ser. No. 60/613,927 filed Sep. 27, 2004 and is hereby incorporated by reference in its entirety for all purposes.

### FIELD OF THE INVENTION

The invention relates to racks for carrying cargo on top of a car. In particular, the invention relates to top racks that include a mechanism for lowering cargo toward or along a side of a vehicle.

### INCORPORATION BY REFERENCE

Each of the following patents and/or patent applications are incorporated by reference in its entirety: U.S. Provisional Patent Application Ser. No. 60/517,665 filed Nov. 3, 2003 titled “Extendable Crossbar”; and U.S. Pat. Nos. 5,360,150; 3,452,893; 3,480,166; 3,828,993; 3,931,919; 3,963,136; 4,003,485; 4,081,095; 4,291,823; 4,339,223; 4,350,471; 4,446,998; 4,516,709; 4,682,719; 4,728,244; 4,826,387; 4,867,362; 4,887,750; 5,058,791; 5,257,710; 5,346,355; 5,348,207; 5,360,150; 5,417,358; 5,505,579; 5,535,929; 5,544,796; 5,560,525; 5,673,831; 5,782,391; 5,884,824; 5,988,470; 6,015,074; 6,105,840; 6,158,638; 6,273,668; 6,357,643; 6,428,263; 6,431,421; 6,467,662 and 6,520,393.

### BACKGROUND

Top racks for carrying cargo on top of vehicles are commonly used. One problem with top racks is that it is often difficult to reach the top of a car to load or unload cargo. The problem is exacerbated when a top rack is used on a large car, and is particularly problematic for people who are short in stature.

### BRIEF DESCRIPTION OF THE DRAWINGS

FIG. 1 is a side view of a rack with side descent mechanism in a carrying position.

FIG. 2 is a side view of the rack of FIG. 1 in a descended position for loading.

FIG. 3 is a side view of another rack in a loading position.

FIG. 4 is a partial side view of the pivoting mechanism in the rack shown in FIG. 3.

FIGS. 5-8 each show a side view of rack using a different side loading assist device.

FIGS. 9 and 10 show side views of another rack design in carrying and loading positions, respectively.

FIG. 11 shows a partial side view of another rack including a side load assist device.

### DISCLOSURE

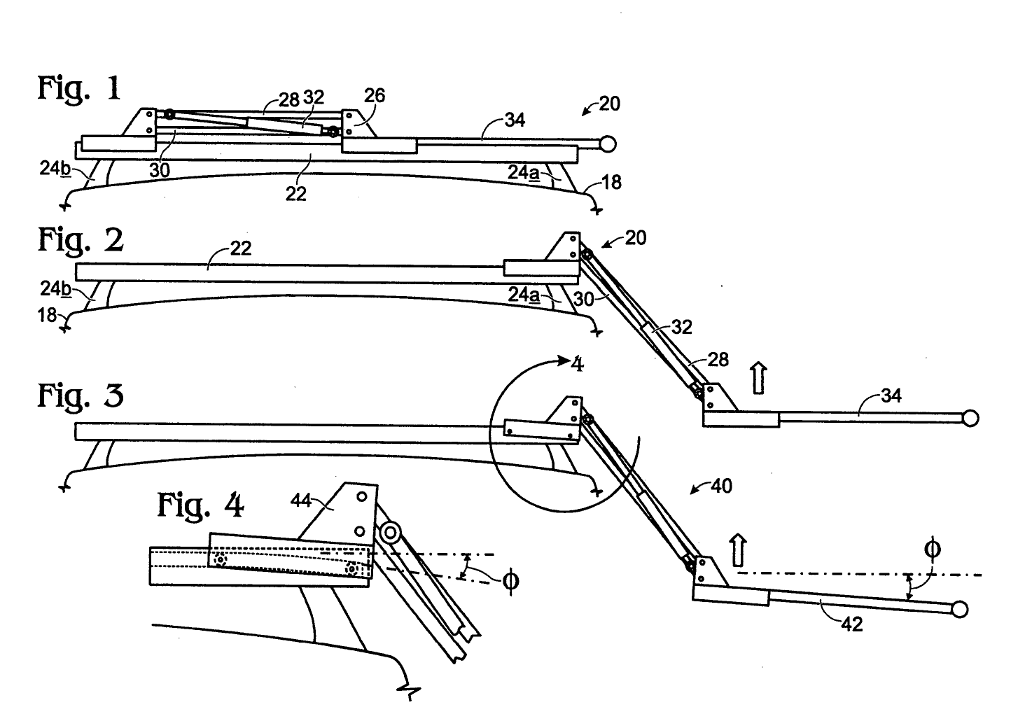

FIG. 1 shows a top profile of vehicle 18 with rack 20 mounted on top. Rack 20 includes fixed or stationary crossbar 22 which is mounted to vehicle 18 via towers 24a and 24b. Sliding assembly 26 is shown in FIG. 1 in a carrying position. When vehicle 18 is transporting cargo on rack 20, sliding assembly 26 is locked in its carrying position. When a person wants to unload cargo from rack 20, sliding assembly 26 may slide along fixed crossbar 22 until it is fully extended over the side of vehicle 18. Sliding assembly 26 uses a parallelogram mechanism formed by top bar 28 and bottom bar 30. Strut 32 connects top bar 28 and bottom bar 30 and is configured to assist with raising and lowering cargo along the side of vehicle 18. Load element 34 is provided for supporting cargo. For example, load element 34 may be provided with numerous different specific removable load-carrying accessories configured to secure specific types of loads, for example, skis, bikes, boats, boxes, baskets, etc.

Many different types of strut devices may be used to assist movement of load element or platform 34. For example, strut 32 may always exert a force pulling bars 28 and 30 together. Alternatively, strut 32 may use a over-center mechanism to push bars 28 and 30 apart in one orientation, and pulling them together in another orientation. A cam device may also be used in strut 32 with a shape that results in load platform 34 being stabilized at various elevations on the side of vehicle 18.

FIG. 2 shows rack 20 with sliding assembly 26 in its loading position. The parallelogram device permits element 34 to descend on the side of vehicle 18 without substantial deviation from a horizontal orientation.

FIGS. 3 and 4 show an alternate rack design 40 configured to permit load element 42 to rotate to some extent off of a horizontal orientation. As shown in FIG. 3, load element 42 deviates from horizontal by φ degrees. As shown in FIG. 4, sliding mount member 44 tips slightly when sliding assembly 26 is completely extended, thereby permitting load element 42 to rotate below a horizontal orientation. In some applications, rotation of load element 42 below horizontal orientation provides easier accessibility to cargo. Depending on the application, φ may be in the range of 5° to 15°, or 5° to 30°.

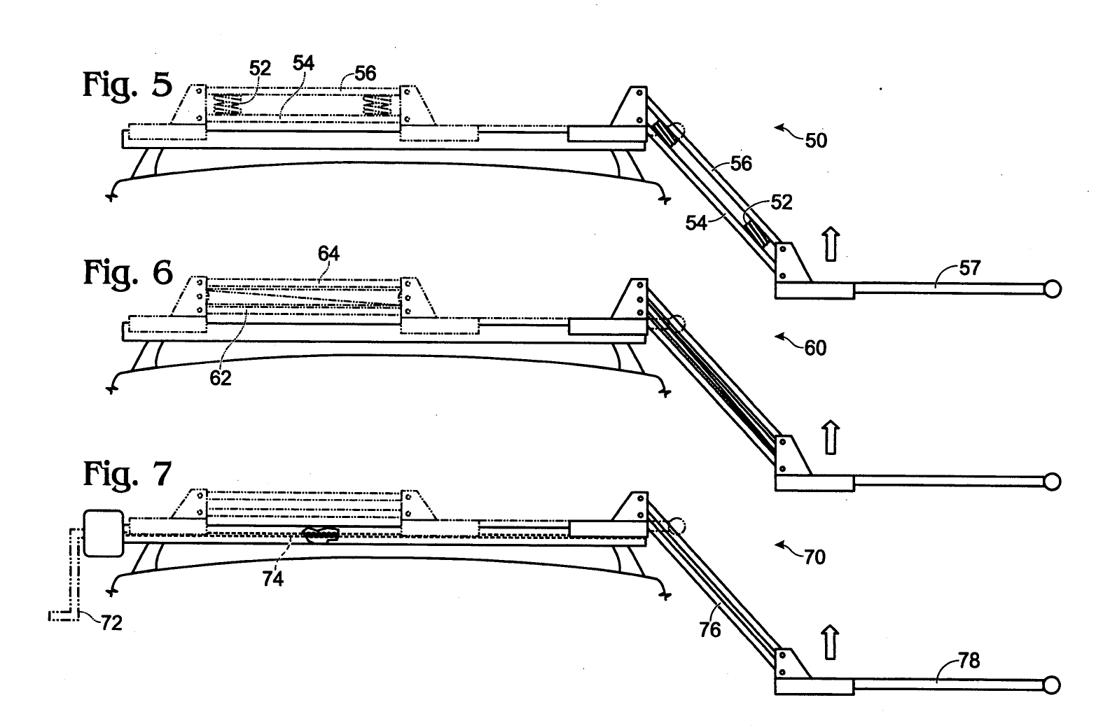

FIG. 5 shows another rack example. Rack 50 is similar to rack 20 in FIG. 1, except springs 52 are positioned between bars 54 and 56. As shown in FIG. 5, when load element 57 is in the down position, bars 54 and 56 move closer together. Springs 52 urge bars 54 and 56 apart causing an upward force or lift-affect on load element 57.

FIG. 6 shows rack 60 which is similar to the previously-described designs except a different lift-assist mechanism is employed. Pulleys (not shown) are incorporated between bars 62 and 64 in a “block and tackle” arrangement to provide a lift advantage.

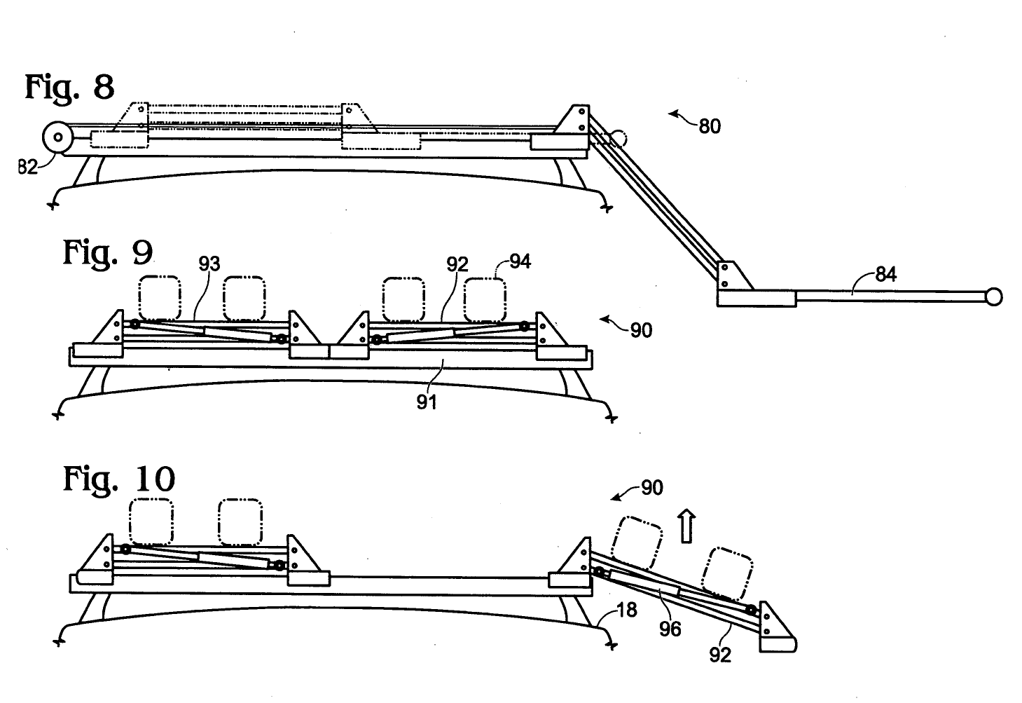

FIG. 7 shows a rack employing a different assist mechanism. Crank 72 can be manipulated to cause rotation of threaded rod 74. Threaded rod 74 impinges on parallel bar assembly 76 in such a way that rotation of crank 72 results in raising and lowering of load element 78. A similar design is shown in FIG. 8 except a motor 82 is provided for driving up and down movement of load element 84.

FIGS. 9 and 10 show a different top rack design 90. Fixed crossbar 91 supports two sliding assemblies, 92 and 93. Each sliding assembly is equipped with mounting accessories 94 for securing specific types of cargo, including but not limited to skis, bikes, boats, boxes, baskets, etc. As shown in FIG. 10, sliding assembly 92 may extend and descend along the side of vehicle 18. Strut 96, or some other lift-assist mechanism, for example, including but not limited to the mechanisms described above, is used to provide an upward force on sliding assembly 92. The design shown in FIGS. 9 and 10 has an advantage over other rack designs shown in FIGS. 1-8 because more of the crossbar length can be used to get a cargo.

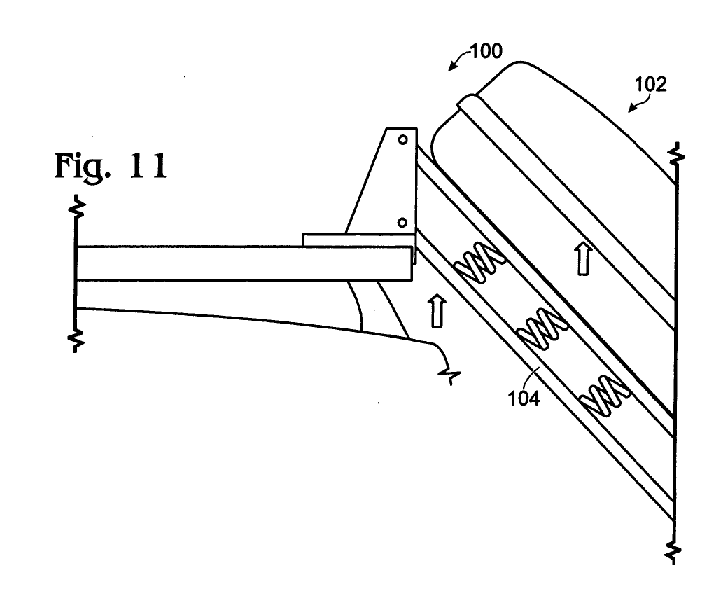

FIG. 11 shows a portion of top rack 100 with cargo box 102 mounted on sliding assembly 104. Box 102 is shaped for accessing contents on an incline when sliding assembly 104 is extended and descended.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications, and variations thereof. Where the disclosure recites “a,” “a first,” or “another” elements, or the equivalent thereof, it should be interpreted to include one or more such elements, neither requiring nor excluding two or more such elements. Furthermore, any aspect shown or described with reference to a particular embodiment should be interpreted to be compatible with any other embodiment, alternative, modification or variation.

We claim:

1. A rack for carrying cargo on top of a car, comprising
at least one crossbar assembly mounted on top of the car substantially perpendicular to the direction of vehicle travel, the crossbar assembly including a stationary structure that remains fixed relative to the top of the vehicle, and a mobile structure that translates perpendicular to the direction of vehicle travel toward a lateral side of the vehicle,
a lowering mechanism permitting an extendable portion of the mobile structure to lower, and
an assist mechanism applying an upward force on the extended portion.

2. The rack of claim 1 wherein the extendable portion stays substantially horizontal during lowering

3. The rack of claim 1 wherein the mobile portion has a parallelogram structure including first and second parallel bars, pivotally connected to the stationary structure, the assist mechanism including a biasing member urging the first and second bars apart.

4. The rack of claim 3 wherein the assist mechanism is a strut.

5. The rack of claim 3 wherein the assist mechanism is a gas strut.

6. The rack of claim 3 wherein the assist mechanism is a spring biased strut.

7. The rack of claim 3 wherein the assist mechanism includes a coiled spring.

8. The rack of claim 1 wherein the assist mechanism includes a motor.

9. The rack of claim 8 wherein the motor is powered by a battery.

10. The rack of claim 8 wherein the battery is powered by a vehicle battery.

11. The rack of claim 1 wherein the assist mechanism includes a winch.

12. The rack of claim 1 wherein the assist mechanism includes a cable and a crank for manually raising and lowering the extendable portion.

13. The rack of claim 1 wherein the rack includes two substantially identical parallel crossbar assemblies.

14. The rack of claim 13 wherein the crossbar assemblies are synchronized so that they extend and lower together.

15. The rack of claim 13 wherein a box is mounted on the extendable portions of the crossbar assemblies.

16. The rack of claim 1 wherein the crossbar assembly includes two parallel crossbar structures, the stationary structure being mounted between the crossbars.
